(19) United States
(12) Patent Application Publication
(10) Pub. No.: US 2006/0009901 A1
(43) Pub. Date: Jan. 12, 2006

(54) Braking device for a motor vehicle

(75) Inventor: Thierry Pasquet, Livry Gargan (FR)

Correspondence Address: LEO H MCCORMICK, 2112 MISHAWAKA AVE, P O BOX 4721, SOUTH BEND, IN, 46634, US

(73) Assignee: Robert Bosch GmbH

(21) Appl. No.: 11/174,353

(22) Filed: Jul. 1, 2005

(30) Foreign Application Priority Data
Jul. 7, 2004 (FR) 04/07575

(51) Int. Cl. G06F 19/00

(52) U.S. Cl. 701/70

(57) ABSTRACT

A motor vehicle braking device (12) including parking brake and a first sensor (16) for detecting the state of a member (14) of the parking brake to provide an item of information to a computer (20) via an electric cable (22) connecting this computer to a an adjacent sensor (18) placed close to the state detection sensor 16).

### BACKGROUND OF THE INVENTION

More precisely, the invention relates to a motor vehicle braking device of the type comprising a parking brake.

It is known practice to fit motor vehicles with electronic driving aid devices to improve road holding or the effectiveness of the braking of the vehicles.

Amongst these electronic aid devices, mention can be made of ABS (Antilock Braking System), which is a device preventing the wheels from locking up during braking, or ESP (Electronic Stability Program) which is a device ensuring the stability of the vehicle particularly in turns or on a slippery pavement.

These electronic aid devices usually use a computer which processes data originating from sensors situated close to the wheels, and which automatically acts on the motor vehicle's braking device. The data are normally transferred between the sensors and the computer via electric cables.

The function of a vehicle parking brake is to immobilize the vehicle's wheels when the latter is parked. The parking brake may be actuated by mechanical or electric means whose correct operation it is desirable to monitor.

However, the addition of means of monitoring the parking brake requires a priori the management of monitoring data that must be transferred via electric cables as is the case with the aforementioned aid devices.

Now, the cost of installing electric cables in a vehicle increases with the number of these cables.

The main aim of the invention is to monitor the correct operation of a parking brake with the aid of simple and effective means, while minimizing the number of additional electric cables necessary for the operation of the means of monitoring the parking brake.

### SUMMARY OF THE INVENTION

As a result, the subject of the invention is a motor vehicle braking device, of the type comprising a parking brake, characterized in that it comprises means for detecting the state of a member of the parking brake, these state detection means providing an item of information to a computer via an electric cable connecting this computer to a device placed close to the state detection means, called the adjacent device.

Thanks to this braking device, the motor vehicle comprises means detecting the state of a member of the parking brake, providing an item of information to the motor vehicle's computer. In addition, since the state detection means use an electric cable shared with the adjacent device, the number of additional cables necessary for the operation of the state detection means is limited.

A braking device according to the invention may also comprise one or more of the following features:
the adjacent device is capable of providing a signal, called the adjacent signal, transmitted via the electric cable, this adjacent signal being able to change between a first value sᵥ¹ and a second value sᵥ² to within a noise level, these two values corresponding respectively to a first and a second state of the adjacent device;
the state detection means provide a signal carrying the item of information on the state of the parking brake, called the state detection signal, intended to be added to the adjacent signal, this state detection signal being capable of taking a first value sₚ¹ and a second value sₚ², corresponding respectively to a state in which the parking brake is deactivated and to a state in which the parking brake is activated;
the four values sᵥ¹+sₚ¹, sᵥ²+sₚ¹, sᵥ¹+sₚ² and sᵥ²+sₚ² of the signal equal to the sum of the adjacent signal and the detection signal are different by twos to within the noise level;
the parking brake member is a key intended to immobilize a brake in a position of immobilization of a vehicle wheel;
the adjacent device comprises a member chosen from a wheel rotation detection device and a brake actuator;
the adjacent device comprises a brake actuator supported by a caliper of the braking device;
the two values of the adjacent signal correspond respectively to a state Eₚ¹ in which the brake actuator is activated and a state Eₚ² in which the brake actuator is deactivated;
the adjacent device comprises a wheel rotation detection device supported by a hub carrier;
the two values of the adjacent signal are provided by the wheel rotation detection device, these two values corresponding respectively to a state Eᵥ¹ in which the wheel is immobile, and a state Eᵥ² in which the wheel is rotating;
the wheel rotation detection device comprises magnetic or optical means supported by a hub carrier of the wheel;
the wheel rotation detection device comprises a Hall effect probe;
the adjacent device is capable of providing a signal characteristic of at least three states of the adjacent device;
the signal provided by the adjacent device is a pulse whose duration is a function of the state of the adjacent device.

The invention will be better understood on reading the following description, given as an example only and made with reference to the appended drawings.

### BRIEF DESCRIPTION OF THE DRAWINGS

FIG. 1 is a diagram of a motor vehicle furnished with a braking device according to the invention;

FIG. 2 is a view of the braking device state detection means according to a first embodiment of the invention;

FIG. 3 is a diagram of an electric circuit comprising different elements of the state detection means according to the first embodiment of the invention;

FIG. 4 is a graph representing the values taken by a signal I_{T} transmitted on the electric cable between the state detection means shown in FIG. 3 and the vehicle's computer, the signal I_{T} being characteristic of the state of the braking device;

FIG. 5 is a view of the braking device state detection means according to a second embodiment of the invention;

FIG. 6 is an electric circuit diagram of one of the elements of the state detection means, according to the second embodiment of the invention; and

FIGS. 7a to 7e are graphs representing over time signals transmitted in the form of pulses between the state detection means, according to a third embodiment, and the vehicle's computer.

### DETAILED DESCRIPTION OF THE INVENTION

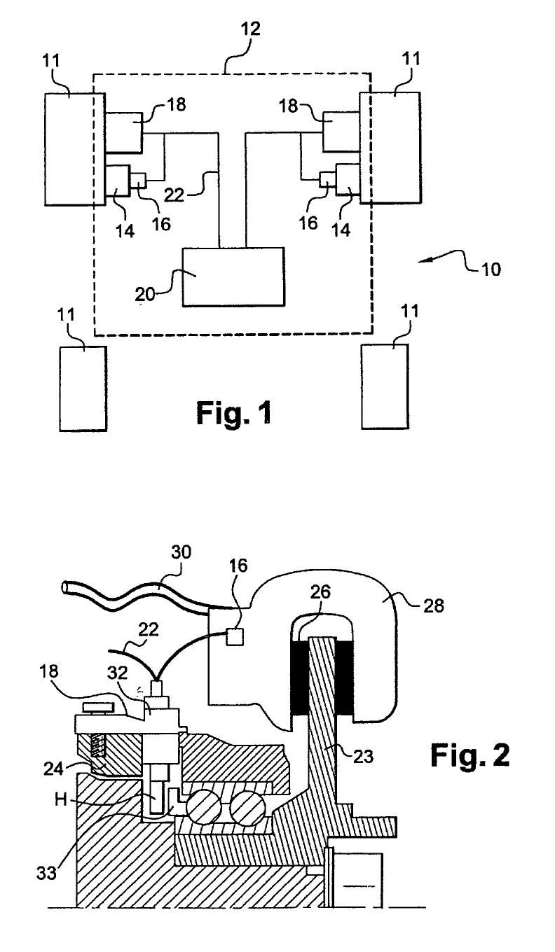

A motor vehicle 10 schematized by four wheels 11 is represented in FIG. 1. The motor vehicle 10 comprises a braking device designated by the general reference number 12. The braking device 12 comprises in particular a parking brake of which only one member 14 placed close to the wheels 11 has been represented. The braking device 12 is furnished with means 16 for detecting the state of the parking brake member 14. These state detection means 16, which will be described later, are suitable for providing data relating to the state of the parking brake member 14.

Close to these state detection means 16, the braking device comprises a device 18 called the adjacent device. The adjacent device 18 interchanges data with a computer 20 of the braking device 12.

The interchanged data are carried by a signal, called the adjacent signal Sᵥ, transmitted on at least one electric cable 22 connecting the computer 20 to the braking device 12.

The adjacent device is, for example, a wheel rotation detection device or a valve of the braking device 12, intended to control the inflow of brake fluid.

The computer 20 is for example the computer of an electronic aid device.

The state detection means 16 are connected to the electric cable 22, in order to be able to transmit to the computer 20 a signal, called the state detection signal Sₚ, carrying the data relating to the state of the parking brake member 14. Thus, the number of additional cables necessary to the operation of the state detection means 16 is limited because the electric cable 22 is common to the transmission of the adjacent signal and of the state detection signal. It may be considered that the adjacent signal Sᵥ and the state detection signal Sₚ are multiplexed on the electric cable 22.

The braking device 12 comprises disk braking means equipping at least the front wheels of the vehicle.

Thus, with reference to FIG. 2, it can be seen that the device 12 comprises, associated with each front wheel of the vehicle, a brake disk 23, represented in

FIG. 2, integral in rotation with the wheel. The brake disk 23 is mobile relative to a hub carrier 24. The braking device 12 comprises brake pads 26 intended to rub against the brake disk 23 to counter its rotation relative to the hub carrier 24. The brake pads 26 are intended to be pressed against the brake disk 23 with the aid of conventional hydraulic means of which a caliper 28 supporting a conventional hydraulic cylinder (not shown) has been represented. These hydraulic means are supplied with brake fluid via a pipe 30.

The state detection means 16 of the parking brake member 14 are supported by the caliper 28. These means 16 detect for example the movement or force sustained by the parking brake member 14. This member 14 may be a key intended to stop the stroke of the hydraulic cylinder in the position in which the wheel is immobilized.

The means 16 may detect two states of the parking brake member 14: a first state in which this member 14 is activated and a second state in which this member 14 is deactivated, which have been designated respectively by Eₚ¹ and Eₚ².

According to a first embodiment shown in FIG. 2, the adjacent device 18 comprises a wheel rotation detection device 32, supported by the hub carrier 24, used for example in an ABS system.

This wheel rotation detection device 32 comprises conventional means of the magnetic or optical type. In the example described, the detection device 32 comprises magnetic means such as a Hall effect probe H, supported by the hub carrier 24, associated with a phonic wheel 33 connected in rotation to the disk 23.

The wheel rotation detection device 32 can detect two states: a first state in which the wheel is immobile and a second state in which the wheel is rotating, which are designated respectively by Eᵥ¹ and Eᵥ².

The four states Eₚ¹, Eₚ², Eᵥ¹ and Eᵥ² detected by the means 16 (the first two) and the device 32 (the last two) correspond respectively to the four signals sₚ¹, sₚ², sᵥ¹ and sᵥ² intended to be transmitted on the electric cable 22.

The transmission to the computer 20, on a single electric cable 22, of the state data of the wheel rotation detection device 32 and of the state data of the state detection means 16 is carried out by means of a simple multiplexing consisting of summing the signals corresponding to the detected states. The various cases are assembled in the following table:

Adjacent device

| Parking brake | Eᵥ¹ | Eᵥ² |
|---|---|---|
| Eₚ¹ | Sᵥ¹ + Sₚ¹ | Sᵥ² + Sₚ¹ |
| Eₚ² | Sᵥ¹ + Sₚ² | Sᵥ² + Sₚ² |

As will be specified in greater detail hereinafter, the values of the signals sₚ¹, sₚ², sᵥ¹ and sᵥ² must comply with certain relationships for the computer 20 to carry out an effective demultiplexing, that is to say for the computer 20 to differentiate between the summed signals.

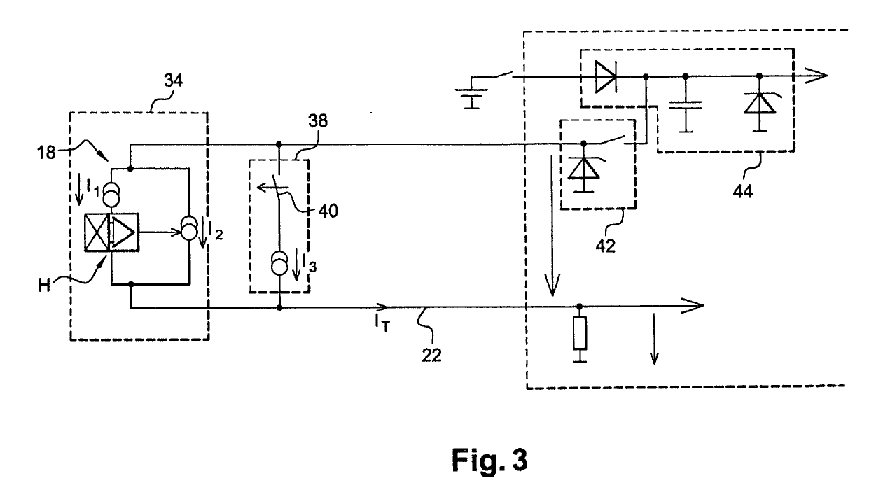

FIG. 3 shows an electric circuit diagram comprising different elements of the state detection means 16 and of the wheel rotation detection device 32 according to the first embodiment of the invention.

The electric circuit comprises a first module 34 comprising the adjacent device 18, and various electric elements associated with the Hall effect probe H, particularly the current generators I₁ and I₂. On the electric cable 22, these generators provide:
a signal sᵥ¹=I₁ when the probe detects the state Eᵥ¹, that is to say when the wheel is immobile, and
a signal sᵥ²=I₁+I₂ when the probe detects the state Eᵥ², that is to say when the wheel is moving.

The electric circuit in FIG. 3 also comprises a second module 38 corresponding to the state detection means 16. To carry out the multiplexing, the second module 38 is connected in parallel with the first module 34. The second module 38 comprises a current generator I₃ controlled by a dry or intelligent contactor 40.

The contactor 40 is open when the parking brake member is in the state Eₚ¹, that is to say when it is deactivated, and is closed when the parking brake member is in the state Eₚ², that is to say when it is activated.

The signal resulting from the multiplexing of the two signals is a current marked I_{T}, transmitted on the electric cable 22. This current is equal to the sum of the currents created by the first two modules 34 and 38. The possible values of the current I_{T} are assembled in the following table:

Adjacent device

| Parking brake | Eᵥ¹ | Eᵥ² |
|---|---|---|
| Eₚ¹ | I₁ | I₁ + I₂ |
| Eₚ² | I₁ + I₃ | I₁ + I₂ + I₃ |

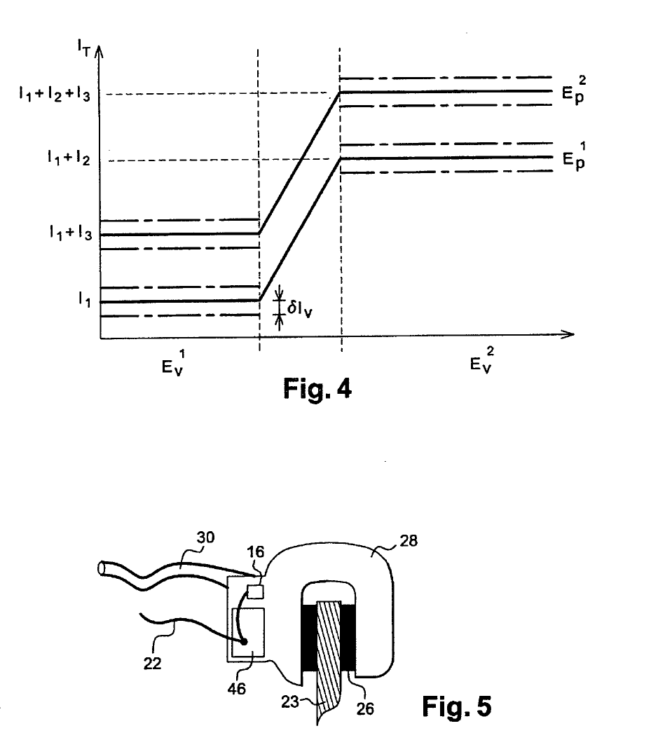

FIG. 4 is a graph representing the values taken by the multiplexed signal I_{T} transmitted on the electric cable 22 as a function of the states Eₚ¹, Eₚ², Eᵥ¹ and Eᵥ² of the wheel rotation detection device 32 and of the state detection device 14.

δIᵥ designates the amplitude of the noise of the adjacent signal provided by the wheel rotation detection device 32. The four states are distinguishable from one another provided that the values of the current I_{T} corresponding to these four states are different by twos to within 2δIᵥ.

If in addition δIₚ designates the amplitude of the state detection signal noise, then the four states are distinguishable from one another provided that the current values I_{T} corresponding to these four states are different by twos to within 2δIᵥ+2δIₚ.

The electric circuit in FIG. 3 also comprises a voltage limiter module 42 whose role is to prevent the signal transmitted on the electric cable from overloading and a stabilization module 44 intended to remove any signal fluctuations.

According to a second embodiment shown in FIG. 5, the adjacent device 18 comprises a brake actuator 46, for example a valve 46 controlling the inflow of brake fluid. This valve 46, which is supported by the caliper 28 of the braking device may have two states: a state Eᵥ¹ in which the caliper 28 is open and a state Eᵥ² in which the caliper 28 is clamped. The information relating to the state of the valve 46 is transmitted to the computer 20 via the electric cable 22.

As in the first embodiment, the parking brake may have two states Eₚ¹ and Eₚ²: a first state in which it is activated and a second state in which it is deactivated.

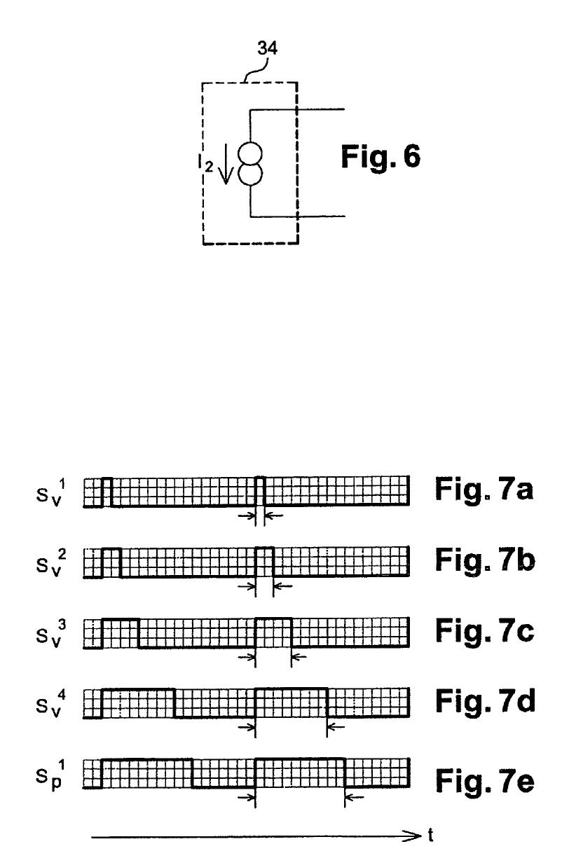

The items of information relating to the state of the parking brake member 14 and the items of information relating to the state of the valve 46 are multiplexed on the electric cable 22. The electric circuit corresponding to the second embodiment is identical to that of the first embodiment shown in FIG. 3, except for the first module 34 which is replaced by that shown in FIG. 6.

The first module 34 shown in FIG. 6 comprises a current generator controlled by the valve 46. The current generator is intended to provide a current I₂ when the valve is activated and a zero current otherwise.

The possible values of the current I_{T} are then assembled in the following table:

Adjacent device

| Parking brake | Eᵥ¹ | Eᵥ² |
|---|---|---|
| Eₚ¹ | 0 | I₂ |
| Eₚ² | I₃ | I₂ + I₃ |

The remarks concerning the prescribed relations between the values of the currents I₁, I₂ and I₃ are identical to those formulated in the description of the first embodiment.

According to a third embodiment not shown, the adjacent device 18 comprises a sensor capable of detecting more than two states. The adjacent device 18 may, for example, be a wheel rotation detection device, also providing an item of information relating to the direction of rotation of the wheel.

The data provided by the adjacent device 18 are carried by the adjacent signal Sᵥ transmitted to the computer 20 on the electric cable 22. The FIGS. 7a to 7d show four representations of the adjacent signal sᵥ¹, sᵥ²m, Sᵥ³ Sᵥ⁴ each corresponding respectively to a state Eᵥ¹, Eᵥ², Eᵥ³, Eᵥ⁴ that can be detected by the adjacent device 18. Each state is coded in the form of a pulse of specific duration such that the pulses can be differentiated from one another.

The signal Sₚ, carrying the data provided by the state detection means 16 of the parking brake member 14, is shown in FIG. 7e. This signal is represented by a pulse sᵥ¹ with a different duration from those of the pulses provided by the adjacent device 18 if the parking brake is activated, and by a signal sᵥ² that is zero if the parking brake is deactivated.

The signals Sₚ and Sᵥ are multiplexed by summing them. The pulses are of different durations, so it is possible to distinguish them and demultiplex the signals.

The number of states that can be transmitted on the electric cable 22 increases as the transmission noise reduces.

What is claimed is:

1. A vehicle braking device (12) comprising a parking brake, characterized by means (16) for detecting the state of a member (14) of the parking brake, said means (16) providing an item of information to a computer (20) via an electric cable (22) that connects said computer (20) to a an adjacent device (18) placed close to the state detection means (16).

2. The vehicle braking device according to claim 1, in which the adjacent device (18) provides an adjacent signal that is transmitted via the electric cable (22), said adjacent signal changing between a first value sᵥ¹ and a second value Sᵥ² within a noise level, said first and second values corresponding respectively to a first and a second state of the adjacent device.

3. The vehicle braking device according to claim 2, in which the state detection means (16) provide a state detection signal carrying the item of information on the state of the parking brake that is added to the adjacent signal, said state detection signal taking a first value sₚ¹ and a second value sₚ², corresponding respectively to a state in which the parking brake is deactivated and to a state in which the parking brake is activated.

4. The motor vehicle braking device according to claim 3, in which values sᵥ¹+sₚ¹, sᵥ²+sᵥ¹, sᵥ¹+sₚ² and sᵥ²+sₚ² of the signal equal to the sum of the adjacent signal and the detection signal are different by twos to within the noise level.

5. The motor vehicle braking device according to claim 4, in which the parking brake member (14) is a key intended to immobilize a brake in a position of immobilization of a vehicle wheel.

6. The motor vehicle braking device according to claim 5, in which the adjacent device comprises a member chosen from a wheel rotation detection device (32) and a brake actuator (46).

7. The motor vehicle braking device according to claim 6, in which the adjacent device comprises a brake actuator (46) supported by a caliper (28) of the braking device.

8. The motor vehicle braking device according to claim 7 in which the values of the adjacent signal correspond respectively to a state Eₚ¹ in which the brake actuator (46) is activated and a state Eₚ² in which the brake actuator (46) is deactivated.

9. The motor vehicle braking device according to claim 6, in which the adjacent device (18) comprises a wheel rotation detection device (32) supported by a hub carrier (24) of the wheel.

10. The motor vehicle braking device according to claim 9 in which the twe values of the adjacent signal are provided by the wheel rotation detection device (32), these two values corresponding respectively to a state Eᵥ¹ in which the wheel is immobile, and a state Eᵥ² in which the wheel is rotating.

11. The motor vehicle braking device according to claim 10, in which the wheel rotation detection device (32) comprises magnetic or optical means supported by a hub carrier (24) of the wheel.

12. The motor vehicle braking device according to claim 11, in which the wheel rotation detection device (32) comprises a Hall effect probe (36).

13. The motor vehicle braking device according to claim 1, in which the adjacent device (18) provides a signal characteristic of at least three states of the adjacent device.

14. The motor vehicle braking device according to claim 13, in which the signal provided by the adjacent device (18) is a pulse whose duration is a function of the state of the adjacent device.
